(19) United States
(12) Patent Application Publication
(10) Pub. No.: US 2020/0238407 A1
(43) Pub. Date: Jul. 30, 2020

(54) MODULAR SHEAR PRESS

(71) Applicant: ACHA S.R.L., Bologna (IT)

(72) Inventor: Cesare BONFIGLIOLI, Castello D'Argile (BO) (IT)

(21) Appl. No.: 16/634,979

(22) PCT Filed: Aug. 29, 2018
(86) PCT No.: PCT/IB2018/056570

§ 371 Date: Jan. 29, 2020

(30) Foreign Application Priority Data
Sep. 27, 2017 (IT) 102017000108166

(51) Int. Cl. B23D 31/00; B23D 33/02

(52) U.S. Cl. CPC B23D 31/008; B23D 33/02

(57) ABSTRACT

A shear press (100) for scrap is described, comprising a machine body (105) defining a compaction channel (125) adapted to contain the scrap and guide it in a sliding manner along a predetermined advance direction (A), compaction means (155) coupled to the machine body (105) and adapted to compact the scrap in the compaction channel (125), and cutting means (180) coupled to the machine body (105) and positioned at one end of the compaction channel (125) to separate the compacted scrap into portions, wherein the machine body (105) comprises at least two mutually separable blocks, of which a first block (105A) to which the compaction means (155) and the cutting means (180) are coupled, and a second block (105B) defining a portion of the compaction channel (125) adapted to serve as a loading hopper for the scrap to be treated.

### FIELD OF THE INVENTION

The present invention relates to a shear press for scrap, typically but not exclusively for metal scrap, which is adapted to cut a mass of scrap, even of significant size, such as automotive bodywork or other scrap, into smaller portions of pressed scrap.

### BACKGROUND ART

As is known, a shear press generally comprises a machine body defining a compaction channel adapted to contain the scrap and guide it in a sliding manner along a predetermined advance direction.

By advancing into the compaction channel, the scrap is pressed by suitable compaction means and then made to proceed towards cutting means that separate them into pieces.

The compaction means and the cutting means are normally placed at the end of the compaction channel, the beginning of which is left substantially clear so that it can act as a loading hopper for the scrap to be treated.

Both the cutting means and the compaction means are installed on board of the machine body, which is currently made as a single monolithic component. Because of this architecture, large and very large shear presses are extremely bulky and heavy, to the point that it is extremely difficult to transport them unless using slow and expensive transport.

### DESCRIPTION OF THE INVENTION

In the light of the foregoing, an object of the present invention is to overcome or at least significantly reduce the above drawback of the prior art.

Another object is to achieve such an object with a simple, rational and relatively cost-effective solution.

These and other objects are achieved with the features of the invention as described in the independent claim 1. The dependent claims describe preferred and/or particularly advantageous aspects of the invention.

Going in more detail, an embodiment of the present invention provides a shear press for scrap comprising a machine body defining a compaction channel adapted to contain the scrap and guide it in a sliding manner along a predetermined advance direction, compaction means coupled to the machine body and adapted to compact the scrap into the compaction channel, and cutting means coupled to the machine body and positioned at one end of the compaction channel to separate the compacted scrap into portions.

According to the invention, the machine body comprises (is divided into) at least two mutually separable blocks, of which a first block to which the compaction means and the cutting means are coupled, and a second block defining a portion of the compaction channel adapted to act as a loading hopper for the scrap to be treated.

With this solution, in order to transport the shear press, it is advantageously possible to separate the two blocks of the machine body, transport them separately and assemble them together at the place of destination.

Since the blocks are individually smaller than the shear press as a whole, each of them can be transported relatively easily and cost-effectively, making the entire transport step easier and more cost-effective as a whole.

According to one aspect of the invention, the first block of the machine body may comprise a first flat flange adapted to be put into contact and be fixed, preferably via disconnectable connecting means (e.g. by bolting) to a corresponding flat flange of the second block.

In this way, the disassembly and assembly of the first and second block are quite simple and fast.

According to another aspect of the invention, the first flat flange of the first block and the corresponding flat flange of the second block may lie in a plane that transversely intersects the compaction channel.

With this solution, the two blocks individually have a smaller length than the machine body as a whole, thus being easier to be carried and handled.

In particular, the plane in which the first flat flange of the first block and the corresponding flat flange of the second block lie may be substantially orthogonal to the advance direction of the scrap in the compaction channel.

In this way, it is advantageously possible to obtain two blocks of regular enough shape to allow an easy transport thereof.

According to another aspect of the invention, the compaction channel may be inferiorly delimited by a bottom plane which is inclined from the top downwards towards the cutting means.

In this way, said bottom plane defines a sort of slide that allows the scrap to advance by the effect of gravity along an inclined advance direction.

According to another aspect of the invention, the machine body may also comprise (be also divided into) a third block, which is removably fixed to the first block on the opposite side with respect to the second block.

Dividing the machine body into three separate blocks increases the portability of the shear press.

In order to facilitate the assembly and disassembly of the third block, the first block of the machine body may comprise a second flat flange adapted to be put into contact and be fixed, preferably via disconnectable connecting means (e.g. by bolting) to a corresponding flat flange of the third block.

Preferably, the second flat flange of the first block and the corresponding flat flange of the third block may lie in a plane parallel to the plane in which the first flat flange of the first block and the corresponding flat flange of the second block lie.

In this way, the first block of the machine body, i.e. that coupled to the compaction means and to the cutting means, has two flat flanges, mutually parallel and opposing, which impart it a rather regular shape and easy to carry.

In particular, prior to transport, the first block of the machine body can may be tipped over and placed resting on the first or, more preferably, on the second flat flange, so as to arrange it with the best possible orientation to be handled and transported

To this end, one aspect of the invention provides that the footprint of the first block, including the cutting means and the compaction means, in a direction orthogonal to the second flat flange is smaller than the footprint of the first block, including the cutting means and the compaction means, in a direction orthogonal to a support plane of the machine body.

With this solution the first block, which generally has quite a large a height with respect to the support plane of the machine body due to the compaction means, the cutting means and the respective hydraulic actuators, when tipped over and placed resting on the second flat flange, has a smaller height which allows it to be transported in a simpler manner and by more cost-effective means of transport.

### BRIEF DESCRIPTION OF THE DRAWINGS

Further features and advantages of the invention will become apparent from the following description, provided by way of non-limiting example with the aid of the figures shown in the accompanying drawings.

FIG. 1 is a schematic side view of a shear press according to the present invention.

FIG. 2 shows a section of the shear press taken according to plane II-II in FIG. 3.

FIG. 3 is section III-Ill shown in FIG. 2.

FIG. 4 is the side view of FIG. 1 shown in a slightly smaller scale and with separated blocks.

FIG. 5 is a schematic side view of one of the blocks in FIG. 4.

FIG. 6 is the side view of the block in FIG. 5 shown in tipped over position.

FIG. 7 is a top view of the block in FIG. 6.

### DETAILED DESCRIPTION

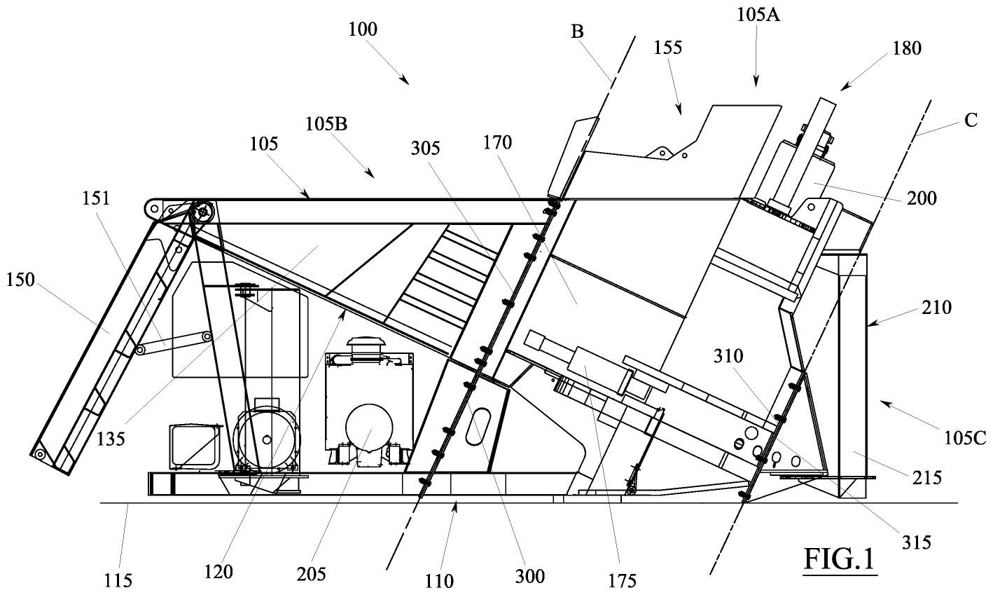

FIG. 1 shows a shear press 100 adapted to cut a mass of scrap into portions of pressed scrap.

In particular, the shear press 100 may be a large machine and may be structured so as to treat even very bulky scrap, such as automotive bodywork or other scrap.

The shear press 100 comprises a machine body, designated as a whole with reference numeral 105, which comprises a base 110 which defines a support plane 115 adapted to be arranged substantially horizontally when the base 100 is placed on the ground.

To this end, it is noted that the base 110 may be put in direct contact with the ground or kept raised through the interposition of other intermediate support structures.

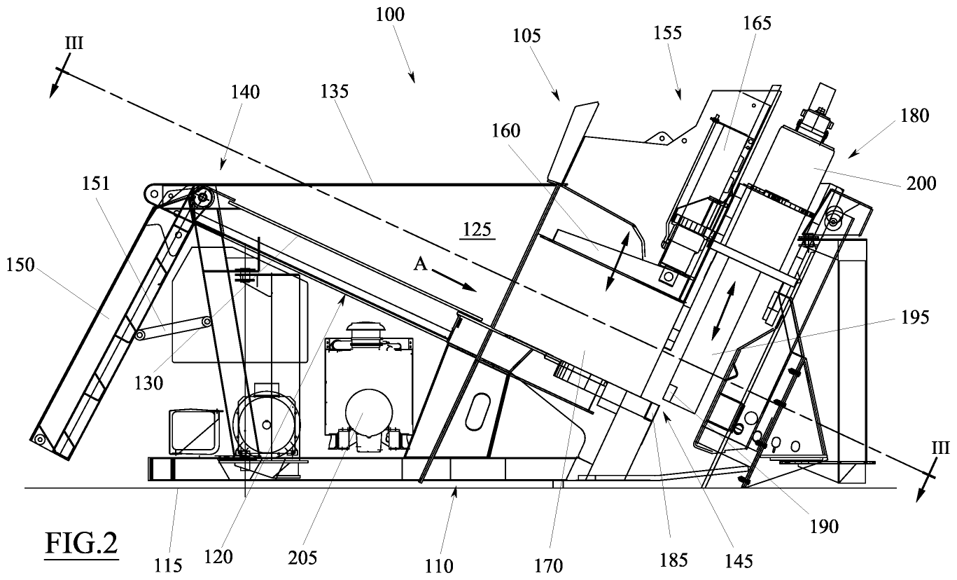

The machine body 105 further comprises an upper structure 120, generally shaped as a body, which is firmly anchored above the base 110 and defines at its interior a compaction channel 125 for the scrap (see FIG. 2).

The compaction channel 125 is inferiorly delimited by a bottom plane 130, which may consist of one or more monolithic plates arranged mutually parallel and in succession.

The bottom plane 130 may be inclined with respect to the support plane 115 of the machine body 105, so as to form an acute angle with the latter, the value of which may for example be in the range of 20° and 30°, preferably about equal to 25°.

In particular, the bottom plane 130 may be inclined for the top downwards starting from an upper end 140, which is placed at the maximum distance from the support plane 115, towards a lower end 145, which is placed at the minimum distance from the support plane 115.

In this way, the bottom plane 130 defines a sort of slide that allows the scrap to slide, by the effect of gravity, from the upper end 140 towards the lower end 145, along a predetermined advance direction indicated with A.

At the upper end 140, a platform 150 may be articulated to the machine body 105 which, actuated by hydraulic jacks 151, may be rotated from a lowered position (shown in the figures) to a raised position, in which it lies substantially coplanar to an extension of the bottom plane 130.

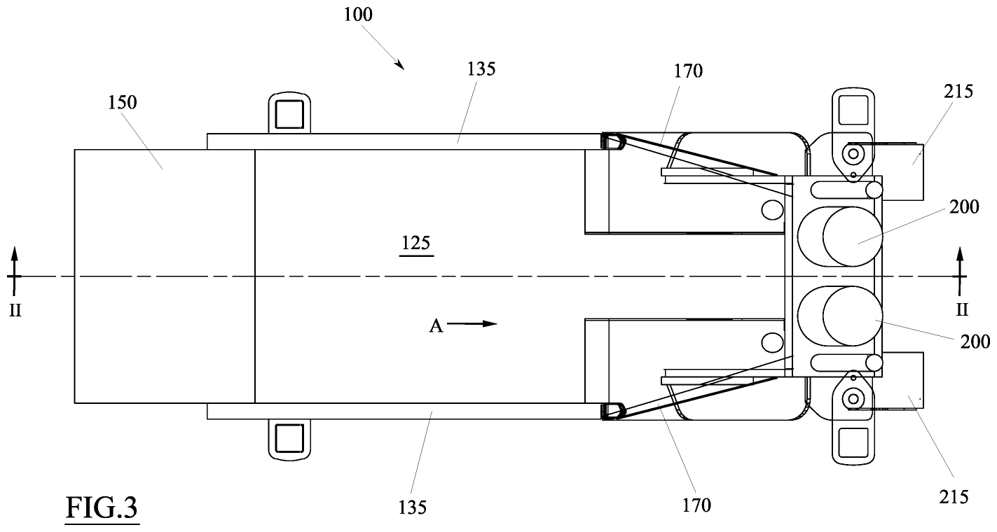

The initial portion of the compaction channel 125, i.e. that proximal to the upper end 140, is open at the top and is bounded by two opposed side walls 135 (see FIG. 3), so as to define a sort of loading hopper for the scrap to be treated.

At a subsequent end portion of the compaction channel 125, i.e. that proximal to the lower end 145, the machine body 105 is associated to compaction means, globally designated with reference numeral 155, which are adapted to press the scrap within said end portion of the compaction channel 125.

The compaction means 155 comprise an upper punch 160 (see FIG. 2), which surmounts the background bottom plane 130 of the compaction channel 125 and is coupled to the machine body 105 so as to be adapted to move with reciprocating motion in a direction orthogonal to the bottom plane 130, in order to press the scrap against the latter.

The movement of the upper punch 160 is implemented through one or more hydraulic cylinders jacks 165, which are installed on the machine body 105 and from which they can protrude upwards, thus increasing the footprint thereof in a direction orthogonal to the support plane 115.

The compaction means 155 further comprise a pair of side jaws 170 (see FIG. 3), which are arranged mutually opposite along the side walls 135 of the compaction channel 125.

Each jaw 170 is articulated to the machine body 105 at the lower end 145 of the compaction channel 125 and according to an articulation axis orthogonal to the bottom plane 130, in such a way as to cyclically rotate in mutual approach/distancing in order to transversely compact the scrap.

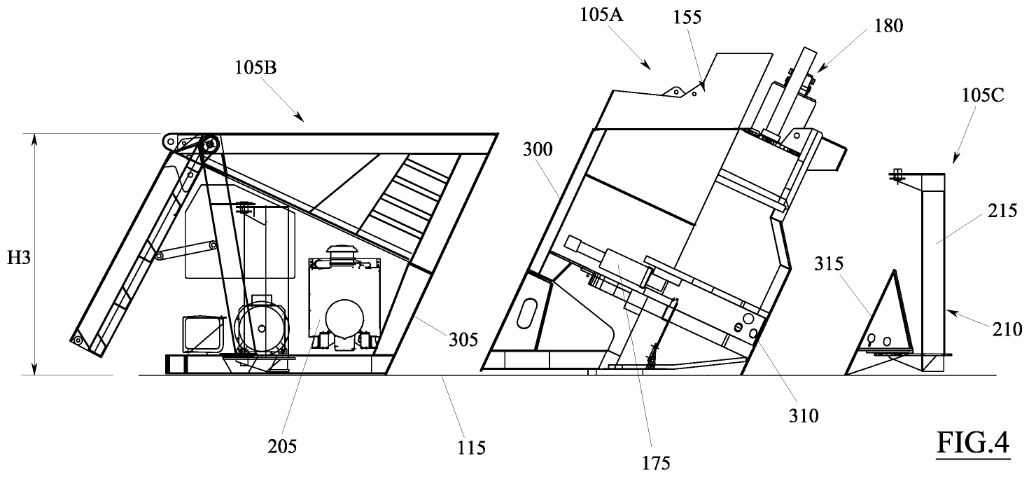

The rotation of each jaw 170 is implemented through a respective hydraulic jack 175, shown in FIGS. 1 and 4, which is installed on the outer side of the machine body 105.

Downstream of the compaction means, with respect to the advance direction A of the scrap, the shear press 100 comprises cutting means 180 adapted to separate the pressed scrap into portions.

The cutting means 180 comprise a first blade 185 (see FIG. 2), which is fixed along the edge of the lower plane 130 of the compaction channel 125 at the lower end 145.

This first blade 185 cooperates with a second blade 190, which is carried by a support crosspiece 195 placed immediately downstream of the compaction channel 125 with respect to the advance direction A.

The support crosspiece 195 is coupled to the machine body 105, for example to a portal structure of the machine body 105, in such a way as to slide with reciprocating motion in a direction orthogonal to the bottom plane 130.

Due to this movement, the first and the second blade 185 and 190 form a shear or guillotine device, which is adapted to cut the compacted scrap progressively exiting from the lower end 145 of the compaction channel 125.

The movement of the support crosspiece 195 is implemented through one or more hydraulic cylinders jacks 200, which are installed on the machine body 105 and from which they can protrude upwards, thus increasing the footprint thereof in a direction orthogonal to the support plane 115.

The hydraulic jacks 165, 175 and 200 which actuate the compaction means 155 and the cutting means 180 are connected to a suitable water supply circuit, the operation of which is made possible by an engine 205, such as an internal combustion engine, which can be placed in the space between the base 110 and the portion of the compaction channel 125 which defines the loading hopper.

Downstream of the cutting means 180, with respect to the advance direction A of the scrap, the machine body 105 finally comprises a support structure 210 (see FIG. 1) which allows the machine weight to be supported and better distributed on the base 110.

This support structure 210 may for example comprise two posts 215, substantially vertical, which rise out of the base 110 to connect with the upper part of the portal structure that carries the cutting means 180.

In the light of the foregoing, the operation of the shear press may be summarized as follows.

The scrap to be treated is loaded from above into the loading hopper defined by the initial portion of the compaction channel 125. Due to the inclination of the bottom plane 130, the scrap slides towards the end portion of the compaction channel 125, where it is subjected to the action of the compaction means 155. The mass of pressed scrap then continues to slide downwards, progressively exiting from the compaction channel 125 to be sheared and separated into smaller portions by the cutting means 180.

According to the present invention (see FIG. 4), the machine body 105 of the shear press 100 is divided into at least two monolithic blocks, of which a first block 105A to which the cutting means 155 and the compaction means 180 are associated, and a second block 105B comprising the initial portion of the compaction channel 125 which defines the loading hopper and to which the engine 205 may be associated.

In order to allow the assembly of the machine body 105, the first block 105A is provided with a first flat flange 300 adapted to be put into contact and to be fixed to a corresponding flat flange 305 of the second block 1058.

As shown in FIG. 7, the flat flange 300 of the first block 105A may be substantially U-shaped delimiting a cross section of the compaction channel 125. The flat flange 305 of the second block 105B (not shown) has substantially the same shape and same dimensions as the flat flange 300, to which it is fixed via disconnectable connecting means, such as a plurality of fastening bolts.

The flat flanges 300 and 305 lie in a plane, ideally designated with B in FIG. 1, which is inclined with respect to the support plane 115 of the machine body 105 and intersects the compaction channel 125 in a transverse direction, i.e. which is not parallel to the support plane 115 nor to the advance direction A of the scrap along the compaction channel 125.

Preferably, the lying plane B of the flat flanges 300 and 305 is orthogonal to the advance direction A of the scrap, for example orthogonal to the bottom plane 130 of the compaction channel 125.

In the embodiment shown in the figures, the machine body 105 is further divided into a third monolithic block 105C, which substantially comprises the above support structure 210 and is removably fixed to the first block 105A, on the side opposite to the second block 105B.

In order to allow the assembly of this third block 105C, the first block 105A is provided with a second flat flange 310, which is adapted to be put into contact and to be fixed to a corresponding flat flange 315 of the third block 105C. The flat flange 315 of the third block 105C has substantially the same shape and same dimensions as the flat flange 310, to which it is fixed via disconnectable connecting means, such as a plurality of fastening bolts.

The flat flanges 310 and 315 lie in a plane, ideally designated with C in FIG. 1, which is preferably parallel to plane B in which the flat flanges 300 and 305 lie.

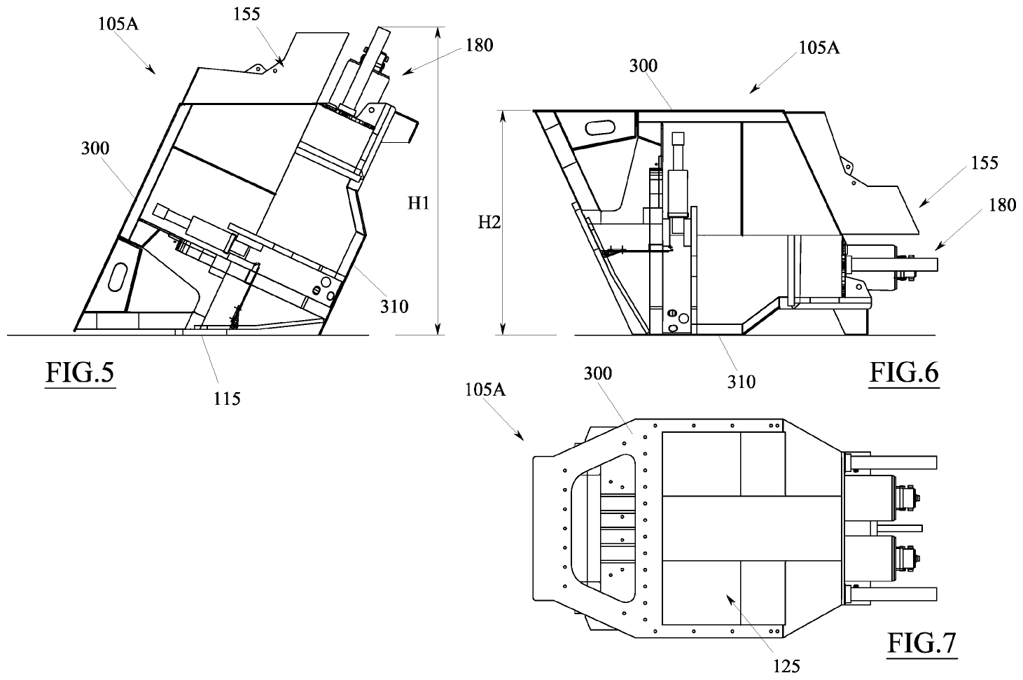

In this way, the first block 105A takes a quire regular shape (see FIG. 5) and, after having been separated from the second block 105B and from the third block 105C, it may be rotated on itself and placed resting on the second flat flange 310 (see FIG. 6).

The distance H2 between the second flat flange 310 and the first flat flange 300, i.e. the overall footprint of the first block 105A in a direction orthogonal to the second flange 310, is selected so as to be smaller than the distance H1 between the support plane 115 and the top of the hydraulic jacks installed on the first block 105A, i.e. than the overall footprint of the first block 105A with respect to the support plane 115.

For example, the distance H2 may be selected so as to be smaller than or equal to the distance H3 between the support plane 115 and the top of the second block 1058 (see FIG. 4).

in this way, when the first block 105A is rotated and placed resting on the second flange 310 as shown in FIG. 6, its height is altogether smaller than the height that it has when it is resting on the support plane 115 as shown in FIG. 5.

With this solution, in order to transport the shear press 100 it is advantageously possible to separate the three blocks 105A, 105B and 105C from each other, rotate the first block 105A so as to place it resting on the second flat flange 310, and finally transport these three blocks separately.

Once the destination site has been reached, the first block 105A can be returned to the original position and be assembled to the other blocks 105B and 105C, thus restoring the integrity of the shear press 100.

Of course, a man skilled in the art may make several technical application changes to the shear press 100 described above, without thereby departing from the scope of the invention as claimed hereinafter.

1. A shear press (100) for scrap comprising a machine body (105) defining a compaction channel (125) adapted to contain the scrap and guide it in a sliding manner along a predetermined advance direction (A), compaction means (155) coupled to the machine body (105) and adapted to compact the scrap in the compaction channel (125), and cutting means (180) coupled to the machine body (105) and positioned at one end of the compaction channel (125) to separate the compacted scrap into portions, characterized in that the machine body (105) comprises at least two mutually separable blocks, of which a first block (105A) to which the compaction means (155) and the cutting means (180) are coupled, and a second block (105B) defining a portion of the compaction channel (125) adapted to serve as a loading hopper for the scrap to be treated.

2. A shear press (100) according to claim 1, characterized in that the first block (105A) of the machine body (105) comprises a first flat flange (300) adapted to be put into contact and to be fixed to a corresponding flat flange (305) of the second block (105B).

3. A shear press (100) according to claim 2, characterized in that the first flat flange (300) of the first block (105A) and the corresponding flat flange (305) of the second block (105B) lie in a plane (B) transversely intersecting the compaction channel (125).

4. A shear press (100) according to claim 3, characterized in that the plane (B) in which the first flat flange (300) of the first block (105A) and the corresponding flat flange (305) of the second block (105B) lie is substantially orthogonal to the advance direction (A) of the scrap in the compaction channel (125).

5. A shear press (100) according to claim 1, characterized in that the compaction channel (125) is inferiorly delimited by a bottom plane (130) which is inclined from the top downwards towards the cutting means (180).

6. A shear press (100) according to claim 1, characterized in that the machine body (105) comprises a third block (105C), which is removably fixed to the first block (105A) on the opposite side with respect to the second block (105B).

7. A shear press (100) according to claim 2, characterized in that the first block (105A) of the machine body (105) comprises a second flat flange (310) adapted to be put into contact and to be fixed to a corresponding flat flange (315) of the third block (105C).

8. A shear press (100) according to claim 7, characterized in that the second flat flange (310) of the first block (105A) and the corresponding flat flange (315) of the third block (105C) lie in a plane (C) parallel to the plane (B) where the first flat flange (300) of the first block (105A) and the corresponding flat flange (305) of the second block (105B) lie.

9. A shear press (100) according to claim 8, characterized in that the footprint of the first block (105A), including the cutting means (180) and the compaction means (155), in a direction orthogonal to the second flat flange (310) is smaller than the footprint of the first block (105A), including the cutting means (180) and the compaction means (155), in a direction orthogonal to a support plane (115) of the machine body (105).

10. A shear press (100) according to claim 6, characterized in that the first block (105A) of the machine body (105) comprises a second flat flange (310) adapted to be put into contact and to be fixed to a corresponding flat flange (315) of the third block (105C).

11. A shear press (100) according to claim 10, characterized in that the second flat flange (310) of the first block (105A) and the corresponding flat flange (315) of the third block (105C) lie in a plane (C) parallel to the plane (B) where the first flat flange (300) of the first block (105A) and the corresponding flat flange (305) of the second block (105B) lie.

12. A shear press (100) according to claim 11, characterized in that the footprint of the first block (105A), including the cutting means (180) and the compaction means (155), in a direction orthogonal to the second flat flange (310) is smaller than the footprint of the first block (105A), including the cutting means (180) and the compaction means (155), in a direction orthogonal to a support plane (115) of the machine body (105).
